(19) United States
(12) Patent Application Publication
(10) Pub. No.: US 2024/0066398 A1
(43) Pub. Date: Feb. 29, 2024

(54) GAMING HEADSET

(71) Applicant: Courtney Robinson, Danville, VA (US)

(72) Inventor: Courtney Robinson, Danville, VA (US)

(21) Appl. No.: 17/897,142

(22) Filed: Aug. 27, 2022

(51) Int. Cl. A63F 13/40; A63F 13/215; A63F 13/25

(52) U.S. Cl. CPC A63F 13/40; A63F 13/215; A63F 13/25

(57) ABSTRACT

A gaming headset, including a main body to be worn on a head of a user, a plurality of speakers disposed on at least a portion of the main body to emit at least one audio signal therefrom, and a control unit disposed within at least a portion of the main body to identify at least one foreign language from a voice of a player and translate the at least one foreign language to a preferred language of the user.

### BACKGROUND

### 1. Field

The present general inventive concept relates generally to a headset, and particularly, to a gaming headset.

### 2. Description of the Related Art

Video games are a rapidly growing market. The integration of the Internet for online play greatly expands a potential player base for people seeking other players with their games. Additionally, online gaming is not just limited to players within a user's own country, but worldwide.

However, for many online and video gamers, communicating with foreigners while playing a video game can be incredibly difficult. The language barrier makes it challenging for players to properly talk with each other, and therefore makes it harder to collaborate and discuss their game plan.

Therefore, there is a need for a gaming headset that can translate any language received to a preferred language of the user.

### SUMMARY

The present general inventive concept provides a gaming headset.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a gaming headset, including a main body to be worn on a head of a user, a plurality of speakers disposed on at least a portion of the main body to emit at least one audio signal therefrom, and a control unit disposed within at least a portion of the main body to identify at least one foreign language from a voice of a player and translate the at least one foreign language to a preferred language of the user.

The control unit may translate the at least one foreign language into the preferred language of the user in real time.

The control unit may prevent the plurality of speakers from emitting the voice of the player in the at least one foreign language.

The control unit may vibrate in Morse code in response to translating the at least one foreign language.

The gaming headset may further include a microphone disposed on at least a portion of the main body to receive at least one audio input therein.

The control unit may translate the at least one audio input into the at least one foreign language previously identified by the control unit to facilitate communication with the player.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a side perspective view of a gaming headset, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Gaming Headset 100
Main Body 110
Speakers 120
Driver 121
Cushion 122
Microphone 130
Tip 131
Boom 132
Control Unit 140
Head Cushion 150
Cord 160

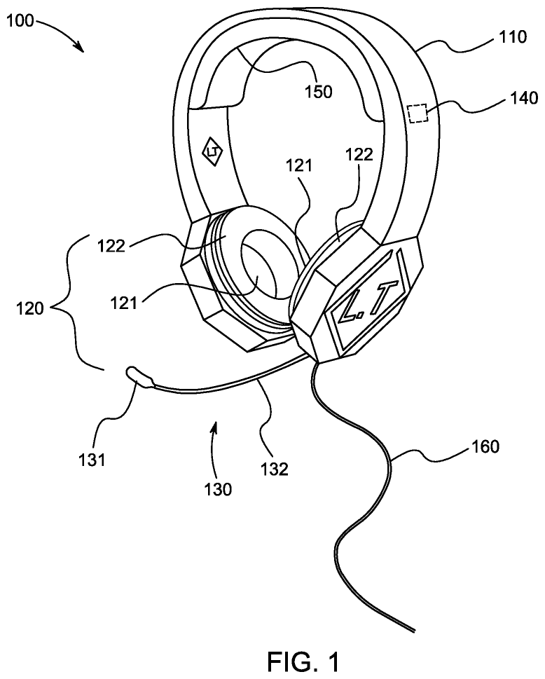

FIG. 1 illustrates a side perspective view of a gaming headset 100, according to an exemplary embodiment of the present general inventive concept.

The gaming headset 100 may be constructed from at least one of metal, plastic, wood, and rubber, etc., but is not limited thereto.

The gaming headset 100 may include a main body 110, a plurality of speakers 120, a microphone 130, a control unit 140, a head cushion 150, and a cord 160, but is not limited thereto.

Referring to FIG. 1, the main body 110 is illustrated to be a headband. However, the main body 110 may be an earpiece, a plurality of earbuds, over-ear headphones, on-ear headphones, or any other type of headphones known to one of ordinary skill in the art, but is not limited thereto.

The main body 110 may be removably disposed on at least a portion of a head of a user. In other words, the main body 110 may be worn on the head of the user.

Each of the plurality of speakers 120 may include a driver 121 and a cushion 122, but is not limited thereto.

Each of the plurality of speakers 120 may be disposed on at least a portion of a first end of the main body 110 and/or a second end of the main body 110 opposite with respect to the first end. Referring again to FIG. 1, the main body 110 is illustrated to have two of the plurality of speakers 120. However, the plurality of speakers 120 may have more than two and/or less than two based on a preference of the user.

The driver 121 may emit at least one audio output therefrom. For example, the driver 121 may emit music, sound effects, and/or a voice of a player.

The cushion 122 may be circumferentially disposed on at least a portion of the main body 110 around the driver 121. In other words, the cushion 122 may surround the driver 121 to form a cup. As such, the cushion 122 may receive an ear of the user therein. The cushion 122 may absorb an impact thereon, such that the cushion 122 may provide comfort for the user while wearing the main body 110.

The microphone 130 may include a tip 131 and a boom 132, but is not limited thereto.

The tip 131 may receive at least one audio input therein. For example, the tip 131 may receive music, sound effects, and/or a voice of the user therein. Additionally, the driver 121 may emit the voice of the user in response to the tip 131 receiving the voice of the user.

The boom 132 may be movably (i.e., rotatably) disposed at a first end on at least a portion of the main body 110. More specifically, the boom 132 may move from disposed in parallel (i.e., pointing from the driver to a top of the main body 110) with the main body 110 in a first position to angularly (e.g., perpendicularly) disposed away from the main body 110 in a second position. Conversely, the boom 132 may move from angularly disposed away from the main body 110 in the second position to disposed in parallel with the main body 110 in the first position. The tip 131 may be disposed on at least a portion of a second end of the boom 132. Also, the boom 132 may extend the tip 131 away from the main body 110.

The control unit 140 may include a processing unit, a communication unit, a haptic unit, and a storage unit, but is not limited thereto.

The processing unit (or central processing unit, CPU) of the control unit 140 may include electronic circuitry to carry out instructions of a computer program by performing basic arithmetic, logical, control and input/output (I/O) operations specified by the instructions. The processing unit of the control unit 140 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processing unit of the control unit 140 may also include a microprocessor and a microcontroller.

The communication unit of the control unit 140 may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, global positioning system (GPS) receiver, USB, Firewire, and Ethernet.

The haptic unit of the control unit 140 may include a vibration motor, but is not limited thereto.

The storage unit of the control unit 140 may include a random access memory (RAM), a read-only memory (ROM), a hard disk, a flash drive, a database connected to the Internet, cloud-based storage, Internet-based storage, or any other type of storage unit.

The control unit 140 may have a software application and/or a mobile application running thereon. For sake of brevity, the software application and/or the mobile application may hereafter be referred to as an app. The control unit 140 may have the app preloaded during manufacture and/or alternatively, the control unit 140 may connect to the Internet to download the app thereon.

The control unit 140 may be disposed within at least a portion of the main body 110. The control unit 140 executing the app may monitor the at least one audio output emitted from the plurality of speakers 120. The control unit 140 may be preconfigured via the app to identify at least one foreign language from a voice of the player and translate the voice of the player to a native and/or a preferred language emitted from the plurality of speakers 120. For example, the control unit 140 may be preconfigured to translate at least one foreign language (e.g., French, Spanish, German, Chinese, etc.) with respect to a language spoken by the user to English. Alternatively, the control unit 140 may translate the at least one foreign language to Spanish. As such, the control unit 140 may seamlessly, simultaneously, and/or in real time (i.e., as the player speaks) translate the at least one foreign language as identified and command the plurality of speakers 120 to emit the at least one audio in the native and/or the preferred language.

Also, the control unit 140 executing the app may prevent the plurality of speakers 120 from emitting the at least one foreign language. In other words, the user may never hear the at least one foreign language, but instead only the native and/or the preferred language. Moreover, the control unit 140 executing the app may translate the at least one audio input (e.g., voice of the user) as previously identified by the control unit 140 into the at least one foreign language recognized by the control unit 140 to facilitate communication with the player.

Furthermore, the control unit 140 executing the app may remotely connect to an external computing device, such as a mobile device, a cell phone, a tablet computer, a laptop computer, a desktop computer, etc. The control unit 140 executing the app may receive commands from the external computing device to program the native and/or the preferred language for playback on the plurality of speakers 120. Moreover, the control unit 140 may vibrate in response to translating the at least one foreign language to Morse code. As such, the control unit 140 may allow a deaf user to understand communication from the player.

Optionally, the control unit 140 may cancel noise from a surrounding environment of the main body 110 and/or the plurality of speakers 120. Thus, the control unit 140 may adjust the at least one audio output from the plurality of speakers 120 to prevent outside noise from interfering with the at least one audio output.

The head cushion 150 may be curvedly disposed on at least a portion of the main body 110. The head cushion 150 may absorb an impact thereon, such that the head cushion 150 may provide comfort for the user while wearing the main body 110. The head cushion 150 may receive a head of the user thereon.

The cord 160 may be disposed on at least a portion of the main body 110. The cord 160 may allow a wired connection to an external device, such as a television and/or the external computing device. Alternatively, the cord 160 may be used as a power inlet to receive power from an external power source (e.g., a power outlet). Alternatively, the cord 160 may be an internal power source, such as a battery and/or a solar cell to provide power for the plurality of speakers 120, the microphone 130, and/or the control unit 140.

Therefore, the gaming headset 100 may translate the at least one foreign language to the native and/or the preferred language of the user. As such, the gaming headset 100 may facilitate game play with players around the world.

The present general inventive concept may include a gaming headset 100, including a main body 110 to be worn on a head of a user, a plurality of speakers 120 disposed on at least a portion of the main body 110 to emit at least one audio signal therefrom, and a control unit 140 disposed within at least a portion of the main body 110 to identify at least one foreign language from a voice of a player and translate the at least one foreign language to a preferred language of the user.

The control unit 140 may translate the at least one foreign language into the preferred language of the user in real time.

The control unit 140 may prevent the plurality of speakers 120 from emitting the voice of the player in the at least one foreign language.

The control unit 140 may vibrate in Morse code in response to translating the at least one foreign language.

The gaming headset 100 may further include a microphone 130 disposed on at least a portion of the main body 110 to receive at least one audio input therein.

The control unit 140 may translate the at least one audio input into the at least one foreign language previously identified by the control unit 140 to facilitate communication with the player.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A gaming headset, comprising:
a main body to be worn on a head of a user;
a plurality of speakers disposed on at least a portion of the main body to emit at least one audio signal therefrom; and
a control unit disposed within at least a portion of the main body to identify at least one foreign language from a voice of a player and translate the at least one foreign language to a preferred language of the user.

2. The gaming headset of claim 1, wherein the control unit translates the at least one foreign language into the preferred language of the user in real time.

3. The gaming headset of claim 1, wherein the control unit prevents the plurality of speakers from emitting the voice of the player in the at least one foreign language.

4. The gaming headset of claim 1, wherein the control unit vibrates in Morse code in response to translating the at least one foreign language.

5. The gaming headset of claim 1, further comprising:
a microphone disposed on at least a portion of the main body to receive at least one audio input therein.

6. The gaming headset of claim 5, wherein the control unit translates the at least one audio input into the at least one foreign language previously identified by the control unit to facilitate communication with the player.
